(19) United States
(12) Patent Application Publication
(10) Pub. No.: US 2024/0406897 A1
(43) Pub. Date: Dec. 5, 2024

(54) METHODS, DEVICES, AND SYSTEMS FOR TRANSMITTING INFORMATION WITH LIMITED CHANNEL BANDWIDTH

(71) Applicant: ZTE Corporation, Shenzhen (CN)

(72) Inventors: Shuai ZHOU, Shenzhen (CN); Xing LIU, Shenzhen (CN); Xianghui HAN, Shenzhen (CN); Chunli LIANG, Shenzhen (CN)

(73) Assignee: ZTE Corporation, Shenzhen (CN)

(21) Appl. No.: 18/800,292

(22) Filed: Aug. 12, 2024

Related U.S. Application Data
(63) Continuation of application No. PCT/CN2022/131516, filed on Nov. 11, 2022.

(51) Int. Cl. H04W 56/00; H04L 1/00; H04L 5/00

(52) U.S. Cl. CPC H04W 56/0015; H04L 1/0071; H04L 5/0051

(57) ABSTRACT

The present disclosure describes methods, systems and devices for transmitting information with limited channel bandwidth. The method includes transmitting, by a base station, a synchronization signal or physical broadcast channel (SS/PBCH) block (SSB) to a user equipment (UE), wherein a channel bandwidth is smaller than a bandwidth of the SSB, by at least one of: indicating, by the base station, an SSB index with at least one bit carried on a PBCH or a PBCH demodulation reference signal (DMRS) in the SSB; mapping, by the base station, at least one of PBCH DMRS or PBCH data on the channel bandwidth or the bandwidth of the SSB; and configuring, by the base station, a resource of a control resource set (CORESET) according to a frequency granularity.

### TECHNICAL FIELD

The present disclosure is directed generally to wireless communications. Particularly, the present disclosure relates to methods, devices, and systems for transmitting information with limited channel bandwidth.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

With the rapid evolution of cellular mobile communication systems, more and more cells will be operated at higher frequencies. For the 5th Generation mobile communication technology, the supported minimum bandwidth may be 5 MHz in normal circumstances. In some special scenarios, such as railway (e.g., future railway mobile communication system (FRMCS)), smart grids, and/or public safety, the available frequency domain resources of some operators may be less than 5 MHz. For example, when the defined minimum bandwidth is less than 3.6 MHz, the original synchronization signal (SS) or physical broadcast channel (PBCH) block may exceed the minimum bandwidth; and the one or more resource block (RB) of SS/PBCH block that exceeds the minimum bandwidth may be punctured, resulting in performance degradation. SSB block may include a primary synchronization signal (PSS) block and/or a secondary synchronization signal (SSS) block. For another example, a limited bandwidth (e.g., less than 3.6 MHz) may reduce an aggregation level supported by a control resource set (CORESET), leading to a shortage of physical downlink control channel (PDCCH) coverage.

The present disclosure describes various embodiments for transmitting information with limited channel bandwidth, addressing at least one of issues/problems discussed above, minimizing the degradation of PBCH reception, minimizing the degradation due to shortage of PDCCH coverage, and thus improving the performance of the wireless communication.

### SUMMARY

This document relates to methods, systems, and devices for wireless communication and more specifically, for transmitting information with limited channel bandwidth.

In one embodiment, the present disclosure describes a method for wireless communication. The method includes transmitting, by a base station, a synchronization signal or physical broadcast channel (SS/PBCH) block (SSB) to a user equipment (UE), wherein a channel bandwidth is smaller than a bandwidth of the SSB, by at least one of: indicating, by the base station, an SSB index with at least one bit carried on a PBCH or a PBCH demodulation reference signal (DMRS) in the SSB; mapping, by the base station, at least one of PBCH DMRS or PBCH data on the channel bandwidth or the bandwidth of the SSB; and configuring, by the base station, a resource of a control resource set (CORESET) according to a frequency granularity.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows a schematic diagram of an exemplary embodiment for wireless communication.

FIG. 2 shows an example of a network node.

FIG. 3 shows an example of a user equipment.

FIG. 4 shows a schematic diagram of an exemplary embodiment for wireless communication.

FIG. 5 shows a flow diagram of a method for wireless communication.

FIG. 6A shows an example of an exemplary embodiment for wireless communication.

FIG. 6B shows an example of an exemplary embodiment for wireless communication.

FIG. 7 shows an example of an exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for transmitting information with limited channel bandwidth.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

With the rapid evolution of cellular mobile communication systems, more and more cells will be operated at higher frequencies. For the 5th Generation mobile communication technology, the supported minimum bandwidth may be 5 MHz in normal circumstances (e.g., when the subcarrier spacing (SCS) is 15 KHz). In some special scenarios, such as railway (e.g., future railway mobile communication system (FRMCS)), smart grids, and/or public safety, the available frequency domain resources of some operators may be less than 5 MHZ (e.g., 2.8˜3.6 MHz or 3 MHZ). For example, when the defined minimum bandwidth is less than 3.6 MHz, the original synchronization signal (SS) or physical broadcast channel (PBCH) block may exceed the minimum bandwidth; and the one or more resource block (RB) of SS/PBCH block that exceeds the minimum bandwidth may be punctured, resulting in performance degradation or failure to work. SSB block may include a primary synchronization signal (PSS) block and/or a secondary synchronization signal (SSS) block. For another example, a limited bandwidth (e.g., less than 3.6 MHZ) may reduce an aggregation level supported by a control resource set (CORESET), leading to a shortage of physical downlink control channel (PDCCH) coverage.

The present disclosure describes various embodiments for transmitting information with limited channel bandwidth, addressing at least one of issues/problems discussed above, minimizing the degradation of PBCH reception, minimizing the degradation due to shortage of PDCCH coverage, and thus improving the performance of the wireless communication.

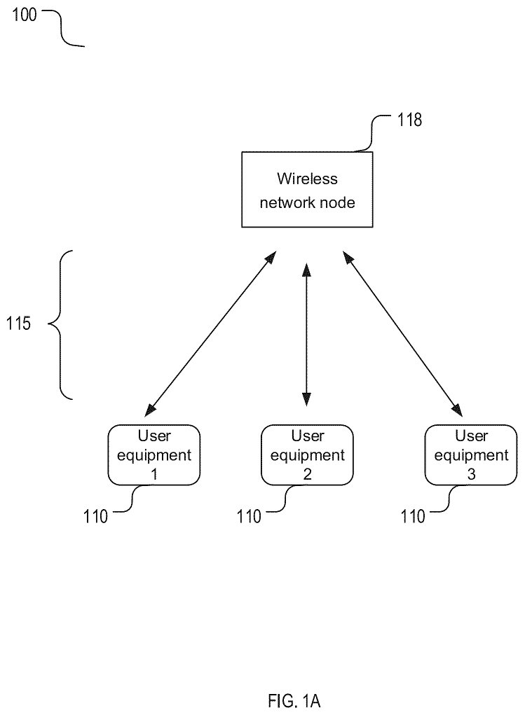

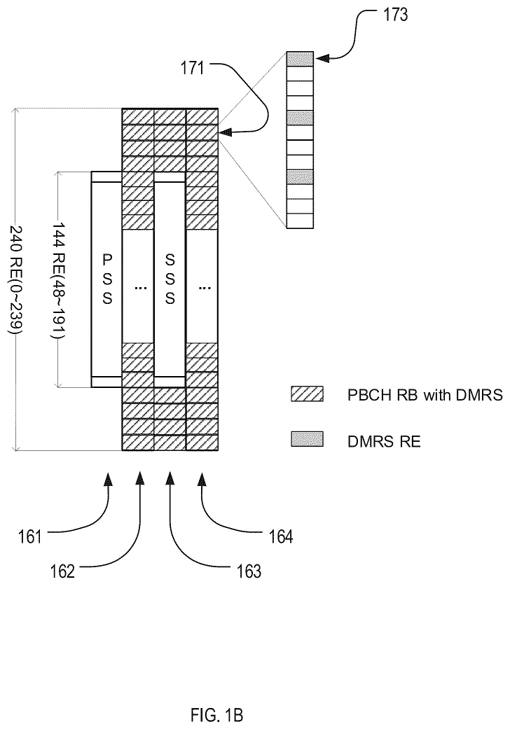

FIG. 1A shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115. For example, a first UE 110 may wirelessly communicate with a wireless network node 118 via a channel including a plurality of radio channels during a certain period of time. The network base station 118 may send high layer signalling to the UE 110. The high layer signalling may include configuration information for communication between the UE and the base station. In one implementation, the high layer signalling may include a radio resource control (RRC) message.

FIG. 1B shows an example of a structure of a synchronization signal (SS)/physical broadcast channel (PBCH) (SS/PBCH) block (SSB). The SS/PBCH block occupies 20 resource blocks (RBs) in the frequency domain and 4 consecutive time domain symbols. The first symbol (161) is mapped to a primary synchronization signal (PSS), the third symbol (163) is mapped to a secondary synchronization signal (SSS) and a physical broadcast channel (PBCH), and the second symbol (162) and the fourth symbol (164) are mapped to PBCH. Each RB (171) of PBCH may include 3 demodulation reference signal (DMRS) resource elements (REs) (173) for channel estimation. In some implementations, a CORESET may occupy the frequency domain resource at least 24 RBs.

In some implementations, the SS/PBCH block consists of 240 contiguous subcarriers (or resource elements (REs)) or 20 RBs in the frequency domain and 4 OFDM symbols in the time domain. The detail resource mapping of signals (including PSS, SSS, PBCH DMRS) and channel (PBCH) are shown in FIG. 1B. More specifically, in time domain, PSS and SSS occupy the first and the third symbol in the SS/PBCH block respectively. And PBCH are mapping in the second, third and fourth symbols. In frequency domain, PSS and SSS occupy RE 48-RE 191. For the second and forth symbols, PBCH occupies all of the 240 REs or 20 PRBs of the SS/PBCH block, and for the third symbol, PBCH occupies RE 0-RE 47 (i.e., RB 0-RB 3) and RE 192-RE 239 (i.e., RB 16-RB 19). In each PBCH PRB, DMRS are mapped on three REs of 12 REs. Then, there are 144 REs are mapped with PBCH DMRS. Accordingly, the sequence length of PBCH DMRS is 144.

In some implementations, for a first frequency range (FR1) (e.g. sub-6 GHz frequency), three-bit timing information, e.g., indicating an SSB index or an SSB index and half frame indication, is carried by PBCH DMRS. Eight sequences, corresponding to 3 bits, may be defined for PBCH DMRS per cell. A UE may first detect the PBCH DMRS sequence from a base station, and then perform channel estimation for PBCH decoding. The UE may obtain the specific location of the SSB, which is determined by the SSB index, in a half frame by performing correlation detection between the DMRS sequence received in an SSB and the eight local DMRS sequences.

In some implementations, in addition to determining the timing information of the potential serving cell during the initial access procedure, the UE may also obtain and report the measured SSB index by identifying the PBCH DMRS sequence of the target cell during neighbor cell measurement.

In some implementations, a physical downlink control channel (PDCCH) may be transmitted in a CORESET by using one or more control channel element (CCE). Each CCE may consist of 6 resource element groups (REGs). The number of CCEs corresponds to a supported PDCCH aggregation level, as indicated in Table 1.

TABLE 1
Supported PDCCH aggregation levels.

| Aggregation level | Number of CCEs |
|---|---|
| 1 | 1 |
| 2 | 2 |
| 4 | 4 |
| 8 | 8 |
| 16 | 16 |

In some implementations, a CORESET may consist of N_{RB}^{CORESET} resource blocks in the frequency domain and N_{RB}^{CORESET}∈{1,2,3} symbols in the time domain. For each CORESET in a downlink (DL) bandwidth part (BWP) of a serving cell, N_{RB}^{CORESET}∈{1,2,3} is given by the higher-layer parameter duration, N_{RB}^{CORESET} is given by the parameter frequencyDomainResources. The parameter frequencyDomainResources provides a bitmap of 45 bits, each bit in the bitmap representative 6 consecutive RBs. In some implementations, the number of RBs in a CORESET may be an integral multiple of six.

In some implementations, for dedicated spectrum less than 5 MHz, only about 12˜16 RBs with 15 kHz subcarrier spacing may be used for 2.8 MHz˜3 MHz channel bandwidth. Then, for SSB with 20 RBs, there are some problems/issues with defining and/or configuring them in the narrow bandwidth. In addition, the aggregation level supported by the CORESET configuration may reduce since the bandwidth is limited, leading to a shortage of PDCCH coverage.

The present disclosure describes various embodiments for transmitting information with limited channel bandwidth, addressing at least one of issues/problems discussed above, minimizing the degradation of PBCH reception, minimizing the degradation due to shortage of PDCCH coverage, and thus improving the performance of the wireless communication.

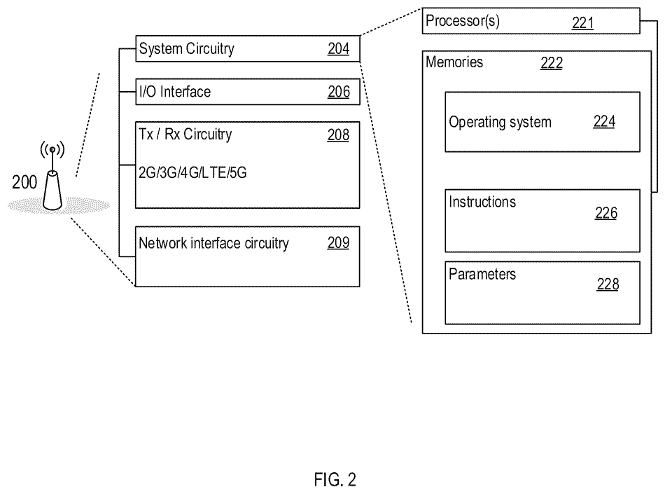

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

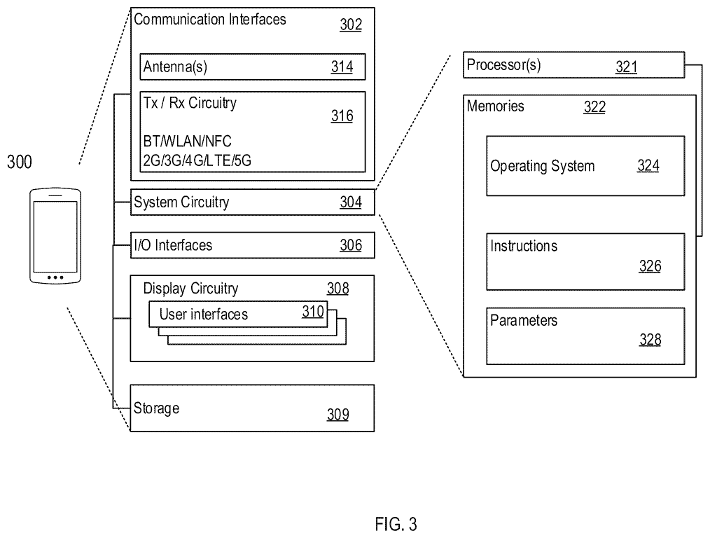

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several below embodiments, which may be implemented, partly or totally, on the network base station and/or the user equipment described above in FIGS. 2-3.

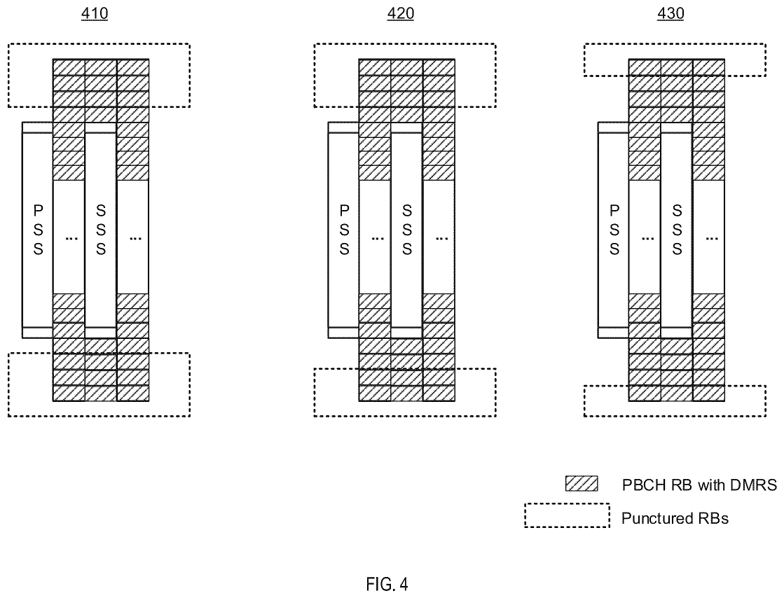

In some implementations, the supported minimum bandwidth may be 5 MHz in normal circumstances (e.g., when the subcarrier spacing (SCS) is 15 KHz). In some special scenarios, such as railway (e.g., future railway mobile communication system (FRMCS)), smart grids, and/or public safety, the available frequency domain resources of some operators may be less than 5 MHZ (e.g., 2.8˜3.6 MHz or 3 MHz). For example, when the defined minimum bandwidth is less than 3.6 MHz, the original synchronization signal (SS) or physical broadcast channel (PBCH) block may exceed the minimum bandwidth; and the one or more resource block (RB) of SS/PBCH block that exceeds the minimum bandwidth may be punctured, resulting in performance degradation or failure to work. FIG. 4A shows a few examples of SS/PBCH blocks for narrowband system: case 1 (411): 2.8 MHz channel bandwidth (CBW); case 2 (412): 3 MHz CBW; and case 3 (413): 3.6 MHz CBW. For case 1, 6 RBs of the existing PBCH as well as PBCH DMRS within these RBs may be punctured. For case 2, the number of RBs punctured is 5, and for case 3, the number of RBs punctured is 2. After puncturing, the DMRS sequence may be divided into multiple segments, which may affect the performance of DMRS sequence detection.

In some implementations, the system bandwidth may be limited within about 3 MHz, and only 16 PRBs or 15 PRB may be used. The CORESET may be configured with a maximum of 12 PRBs bandwidths in accordance with the configuration rule of the multiple of 6 PRBs. In some implementations, for 3 symbols CORESET configuration, the maximum aggregation level may only be 4, which may affect the performance of PDCCH decoding in the CORESET.

The present disclosure describes various embodiments for transmitting information with limited channel bandwidth, addressing at least one of issues/problems discussed above, minimizing the degradation of PBCH reception, minimizing the degradation due to shortage of PDCCH coverage, and thus improving the performance of the wireless communication.

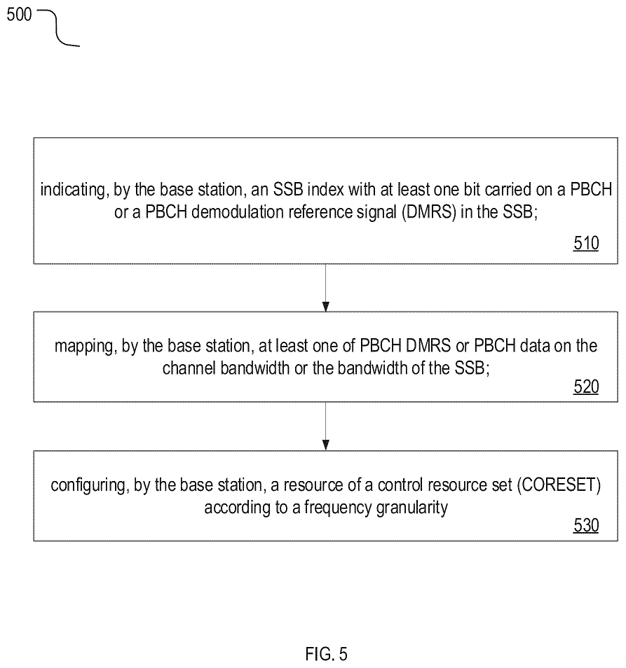

Referring to FIG. 5, the present disclosure describes various embodiments of a method 400 for transmitting, by a base station, a synchronization signal or physical broadcast channel (SS/PBCH) block (SSB) to a user equipment (UE), wherein a channel bandwidth is smaller than a bandwidth of the SSB. The method 500 may include a portion or all of the following steps: step 510: indicating, by the base station, an SSB index with at least one bit carried on a PBCH or a PBCH demodulation reference signal (DMRS) in the SSB; step 520: mapping, by the base station, at least one of PBCH DMRS or PBCH data on the channel bandwidth or the bandwidth of the SSB; and/or step 530: configuring, by the base station, a resource of a control resource set (CORESET) according to a frequency granularity.

In various embodiments, a UE may receive, from a base station, a synchronization signal or physical broadcast channel (SS/PBCH) block (SSB), wherein a channel bandwidth is smaller than a bandwidth of the SSB. In some implementations, the UE may derive an SSB index with at least one bit carried on a PBCH or a PBCH demodulation reference signal (DMRS) in the SSB, wherein the base station indicates the SSB index with at least one bit carried on the PBCH or the PBCH DMRS in the SSB. In some implementations, the UE may receive at least one of PBCH DMRS or PBCH data on the channel bandwidth or the bandwidth of the SSB from the base station, wherein the base station maps at least one of PBCH DMRS or PBCH data on the channel bandwidth or the bandwidth of the SSB. In some implementations, the UE may receive a control resource set (CORESET) according to a frequency granularity from the base station, wherein the base station configures a resource of the CORESET according to the frequency granularity.

In some implementations, the indicating the SSB index with at least one bit carried on the PBCH or the PBCH DMRS in the SSB comprises: in response to a number of sequences for PBCH DMRS being one: in response to a maximum number of SSBs being four, indicating the SSB index with two bits from a set of bits in a PBCH payload or an information element in a master information block (MIB); and/or in response to the maximum number of SSBs being eight, indicating the SSB index with three bits from the set of bits in the PBCH payload or the information element in the MIB.

In some implementations, the indicating the SSB index with at least one bit carried on the PBCH or the PBCH DMRS in the SSB comprises: in response to a number of sequences for PBCH DMRS being two: indicating a least significant bit (LSB) of the SSB index by initializing a scrambling sequence generator of PBCH DMRS sequence based on the LSB of the SSB index; and/or in response to a maximum number of SSBs being four, indicating a most significant bit (MSB) of the SSB index with one bit from a set of bits in a PBCH payload or an information element in a MIB; and/or in response to the maximum number of SSBs being eight, indicating two MSBs of the SSB index with two bits from the set of bits in the PBCH payload or the information element in the MIB.

In some implementations, the indicating the SSB index with at least one bit carried on the PBCH or the PBCH DMRS in the SSB comprises: in response to a number of sequences for PBCH DMRS being four: indicating two LSBs of the SSB index by initializing a scrambling sequence generator of PBCH DMRS sequence based on the two LSBs of the SSB index; and/or in response to the maximum number of SSBs being eight, indicating a MSB of the SSB index with one bit from a set of bits in a PBCH payload or an information element in a MIB.

In some implementations, the set of bits in the PBCH payload comprises three bits in the PBCH payload; and/or the information element in the MIB comprises at least one of an ssb-SubcarrierOffset or a subCarrierSpacingCommon.

In some implementations, the three bits in the PBCH payload comprises a sixth bit, a seventh bit, and an eighth bit in the PBCH payload.

In some implementations, the SSB comprises a first number of resource blocks (RBs) in the frequency domain, the channel bandwidth comprises a second number of RBs in the frequency domain, and the second number is smaller than the first number; and/or the mapping at least one of PBCH DMRS or PBCH data on the channel bandwidth or the bandwidth of the SSB comprises: mapping the PBCH data to consecutive resource elements to the first number of RBs, and/or transmitting the PBCH data within the second number of RBs.

In some implementations, the SSB comprises a first number of resource blocks (RBs) in the frequency domain; the channel bandwidth comprises a second number of RBs in the frequency domain, and the second number is smaller than the first number; and/or the mapping at least one of PBCH DMRS or PBCH data on the channel bandwidth or the bandwidth of the SSB comprises: mapping the PBCH data to consecutive resource elements to the second number of RBs, and/or transmitting the PBCH data within the second number of RBs.

In some implementations, a secondary synchronization signal (SSS) in the SSB is used for channel estimation.

In some implementations, the SSB comprises a first number of resource blocks (RBs) in the frequency domain, the channel bandwidth comprises a second number of RBs in the frequency domain, and the second number is smaller than the first number; and/or the mapping at least one of PBCH DMRS or PBCH data on the channel bandwidth or the bandwidth of the SSB comprises: mapping the PBCH DMRS to the first number of RBs in an order of firstly mapping a low frequency part of the PBCH DMRS to the time domain and then mapping a high frequency part to the time domain, and/or transmitting the PBCH DMRS within the second number of RBs.

In some implementations, the configuring the resource of the CORESET according to the frequency granularity comprises: determining the frequency granularity of the CORESET according to at least one of the following: the channel bandwidth or a high layer signaling.

In some implementations, the high layer signaling comprises a radio resource control (RRC) signaling.

In some implementations, the configuring the resource of the CORESET according to the frequency granularity comprises: determining the frequency granularity of the CORESET according to a predefined rule based on the channel bandwidth.

In some implementations, the configuring the resource of the CORESET according to the frequency granularity comprises: determining an index indicating the frequency granularity of the CORESET and the channel bandwidth according to a predefined table; and/or transmitting the index to the UE via a high layer signaling.

In some implementations, the configuring the resource of the CORESET according to the frequency granularity comprises: determining the frequency granularity of the CORESET among a pre-configured frequency granularity set; and/or transmitting the frequency granularity of the CORESET to the UE via a high layer signaling.

In some implementations, the configuring resource of the CORESET according to the frequency granularity comprises: determining a pre-configured frequency granularity set according to the channel bandwidth; determining an index indicating the frequency granularity of the CORESET among the pre-configured granularity set; and/or transmitting the index to the UE via a high layer signaling.

### Embodiment Set I

The present disclosure describes various embodiments of a method, a system, or computer-readable medium for indicating SSB index reliable by using at least one of bit carried on PBCH and PBCH DMRS.

In various embodiments, only one sequence for PBCH DMRS is defined per cell. In some examples, the PBCH DMRS is used for channel estimation and measurement. The base station may initialize a scrambling sequence generator of PBCH DMRS sequence by defining parameter ī_{SSB} equals to a fixed value, e.g., ī_{SSB}=0 in the following equation.

$${c}_{i n i t} = {2}^{11} ( {\overline{i}}_{SSB} + 1 ) ( ⌊ {N}_{ID}^{cell} / 4 ⌋ + 1 ) + {2}^{6} ( {\overline{i}}_{SSB} + 1 ) + ( {N}_{I D}^{cell} mod 4 )$$

C_init is an initial value and N_{ID}^{cell} is the cell identifier (ID) number.

In some implementations, the maximum number of SS/PBCH blocks is 4, and corresponding SSB indexes are 0, 1, 2, and 3, respectively. Thus, 2 bits are required for indicating the SSB index. The 2 bits may be either 2 bits of the following three bits (i.e., ā_{Ā+5}, ā_{Ā+6}, ā_{Ā+7}) in the PBCH payload. In some implementations, the ā_{Ā+5}, ā_{Ā+6}, ā_{Ā+7} may be used for indicating 3 MSBs of the SSB index in a second frequency range (FR2, e.g., 24,250 MHz to 52,600 MHz). In some implementations, the 2 bits may be either 2 bits of an ssb-SubcarrierOffset or a subCarrierSpacingCommon in the MIB.

In some implementations, the maximum number of SS/PBCH blocks is 8, and the corresponding SSB indexes may be be 0, 1, 2, 3, 4, 5, 6, and 7 respectively. Thus, 3 bits are required for indicating the SSB index. The 3 bits may be ā_{Ā+5}, ā_{Ā+6}, ā_{Ā+7} in the PBCH payload. In some implementations, the ā_{Ā+5}, ā_{Ā+6}, ā_{Ā+7} are used for indicating 3 MSBs of the SSB index in the FR2. In some implementations, the 3 bits may be either 3 bits of an ssb-SubcarrierOffset or a subCarrierSpacingCommon in the MIB.

In various embodiments, only two sequences for PBCH DMRS is defined per cell. The two different sequences are used to indicate 1 LSB of SSB index. In other words, the PBCH DMRS sequence is initialized by the 1 LSB of SSB index. The base station may initialize a scrambling sequence generator of PBCH DMRS sequence by defining parameter ī_{SSB} equals to 1 LSB of the SSB index in the following equation.

$${c}_{i n i t} = {2}^{11} ( {\overline{i}}_{SSB} + 1 ) ( ⌊ {N}_{ID}^{cell} / 4 ⌋ + 1 ) + {2}^{6} ( {\overline{i}}_{SSB} + 1 ) + ( {N}_{I D}^{cell} mod 4 )$$

In some implementations, the maximum number of SS/PBCH blocks is 4, and corresponding SSB indexes may be 0, 1, 2, and 3, respectively. Thus, another 1 bit is required for indicating 1 MSB of the SSB index. The 1 bit can be either one of the following three bits (i.e., ā_{Ā+5}, ā_{Ā+6}, ā_{Ā+7}) in the PBCH payload. In some implementations, the ā_{Ā+5}, ā_{Ā+6}, ā_{Ā+7} are used for indicating 3 MSBs of the SSB index in the FR2. In some implementations, the 1 bit can be either one bit of an ssb-SubcarrierOffset or a subCarrierSpacingCommon in the MIB.

In some implementations, the maximum number of SS/PBCH blocks is 8, and corresponding to the SSB indexes may be 0, 1, 2, 3, 4, 5, 6, and 7, respectively. Thus, 3 bits are required for indicating the SSB index. In some implementations, another 2 bits can be any 2 bits of ā_{Ā+5}, ā_{Ā+6}, ā_{Ā+7} in the PBCH payload. In some implementations, the ā_{Ā+5}, ā_{Ā+6}, ā_{Ā+7} are used for indicating 3 MSBs of the SSB index in the FR2. In some implementations, the 2 bits can be any 2 bits of an ssb-SubcarrierOffset or a subCarrierSpacingCommon in the MIB.

In various embodiments, four sequences for PBCH DMRS is defined per cell. The four different sequences are used to indicate 2 LSBs of the SSB index. In other words, the PBCH DMRS sequence is initialized by the 2 LSB of SSB index. The base station may initialize a scrambling sequence generator of PBCH DMRS sequence by defining parameter ī_{SSB} equals to 2 LSBs of the SSB index in the following equation.

$${c}_{i n i t} = {2}^{11} ( {\overline{i}}_{SSB} + 1 ) ( ⌊ {N}_{ID}^{cell} / 4 ⌋ + 1 ) + {2}^{6} ( {\overline{i}}_{SSB} + 1 ) + ( {N}_{I D}^{cell} mod 4 )$$

In some implementations, the maximum number of SS/PBCH blocks is 8, and corresponding SSB index may be 0, 1, 2, 3, 4, 5, 6, and 7, respectively. Thus, another 1 bit is required for indicating 1 MSB of the SSB index. The 1 bit can be either one of the following three bits (i.e., ā_{Ā+5}, ā_{Ā+6}, ā_{Ā+7}) in the PBCH payload. In some implementations, the ā_{Ā+5}, ā_{Ā+6}, ā_{Ā+7} are used for indicating 3 MSBs of the SSB index in the FR2. In some implementations, the 1 bit can be either one bit of an ssb-SubcarrierOffset or a subCarrierSpacingCommon in the MIB.

In various embodiments, the cce-REG-Mapping Type of CORESET #0 can be indicated in PBCH. For example, 1 bit carried on PBCH is used to indicate ‘interleaved’ or ‘nonInterleaved’ for CORESET #0. More specifically, the 1 bit can be either one bit in PBCH payload (e.g., one bit of ā_{Ā+5}, ā_{Ā+6}, ā_{Ā+7}). In some implementations, the 1 bit can be either one bit of an ssb-SubcarrierOffset or a subCarrierSpacingCommon in the MIB.

In various embodiments, the configuration parameters under ‘interleaved’ type are defined as default values. For example, reg-BundleSize=6, interleaverSize=2, and physical cell ID is used for determining the cyclic shift of the interleaving unit.

In various embodiments, at least one of the configuration parameters under ‘interleaved’ type are configured via information carried on PBCH. For example, the configuration parameters contain reg-BundleSize, interleaverSize, and shiftIndex. And the information carried on PBCH can be bits in PBCH payload (e.g., at least one of bits ā_{Ā+5}, ā_{Ā+6}, ā_{Ā+7}) or bits of an ssb-SubcarrierOffset or a subCarrierSpacingCommon in the MIB.

In various embodiments, SSB or PBCH are transmitted in a repetition manner. And the number of PBCH or SSB repetition is indicated by PBCH DMRS or information carried on PBCH.

In various embodiments, PBCH or PBCH DMRS are transmitted in a power boosting manner. That is, the transmission of PBCH or PBCH DMRS are transmitted using a larger power. E.g., the transmission power of PBCH or PBCH DMRS are 3 dB higher than the transmission power of PSS or SSS. And the power boosting quantity can be indicated by bits in PBCH payload (e.g., at least one of bits ā_{Ā+5}, ā_{Ā+6}, ā_{Ā+7}) or bits of an ssb-SubcarrierOffset or a subCarrierSpacingCommon in the MIB.

### Embodiment Set II

The present disclosure describes various embodiments of a method, a system, or computer-readable medium for remapping at least one of PBCH DMRS and PBCH data within a dedicated spectrum.

In some implementations, the degradation of PBCH performance is caused by the puncturing of data REs and DMRS REs, which leads to the degradation of channel estimation performance.

In some implementations, the method includes mapping PBCH data to consecutive frequency domain resources (such as REs).

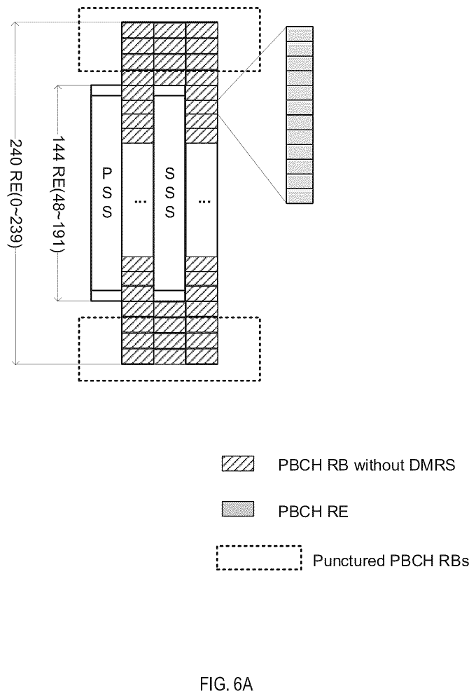

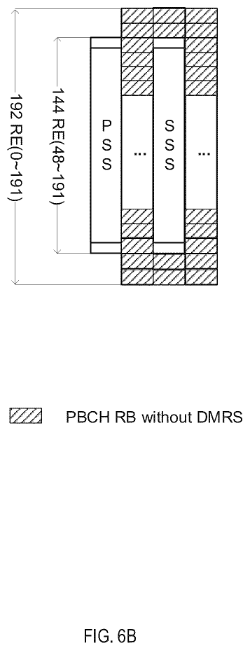

In some implementations, the method includes mapping PBCH data to consecutive REs in the 20 RBs, and the RBs beyond the narrow system bandwidth may still be removed. FIG. 6A shows the structure of SS/PBCH block without DMRS for a narrowband system.

TABLE 2
Resources within an SS/PBCH block for PSS, SSS, PBCH data

| | OFDM symbol number l | Subcarrier number k |
|---|---|---|
| Channel or | relative to the start | relative to the start |
| signal | of an SS/PBCH block | of an SS/PBCH block |
| PSS | 0 | 24, 25, . . . , 167 |
| SSS | 2 | 24, 25, . . . , 167 |
| Set to zero | 0, 2 | 24, 25, . . . , 31 |
| | | 159, 160, . . . , 167 |
| PBCH data | 2 | 0, 1, . . . , 23 |
| | | 167, 169, . . . , 191 |
| | 1, 3 | 0, 1, . . . , 191 |

In various embodiments, the method may include mapping PBCH data to consecutive REs within 16 RBs. As the length of PBCH data sequence is 432 according to the current coding and modulation scheme, PBCH data may be exactly mapped to 432 REs (i.e., 6 RBs) as shows in FIG. 6B and Table 2. In some implementations, the UE may receive complete PBCH data.

In some implementations, the method includes using rate matching to map PBCH data to continuous frequency domain resources within the available bandwidth of the narrowband system.

In some implementations, the SSS is used for channel estimation.

In some implementations, the DMRS sequence is mapped to a part REs of PBCH RBs that have bandwidths that are within the bandwidth of or corresponding to the PSS and/or SSS. The mapping can be performed according to a suitable mechanism predefined by the specification. In some arrangements, as shown in Table 3, the DMRS sequence is mapped to the second symbol within an SS/PBCH block (i.e., OFDM symbol number 1 relative to the start of an SS/PBCH block) from low frequency to high frequency. Then, the DMRS sequence is mapped to the fourth symbol within the SS/PBCH block (i.e., OFDM symbol number 3 relative to the start of an SS/PBCH block) from low frequency to high frequency. The quantity v in Table 3 is determined according to physical layer cell identity N_{ID}^{cell}, for example, v=N_{ID}^{cell} mod 4.

TABLE 3
Resources within an SS/PBCH block for PSS, SSS, PBCH data

| | OFDM symbol number l | Subcarrier number k |
|---|---|---|
| Channel or | relative to the start | relative to the start |
| signal | of an SS/PBCH block | of an SS/PBCH block |
| PSS | 0 | 24, 25, . . . , 167 |
| SSS | 2 | 24, 25, . . . , 167 |
| Set to zero | 0, 2 | 24, 25, . . . , 31 |
| | | 159, 160, . . . , 167 |
| PBCH | 2 | 0, 1, . . . , 23 |
| | | 167, 169, . . . , 191 |
| | 1, 3 | 0, 1, . . . , 191 |
| PBCH DMRS | 1, 3 | 24 + ν, 28 + ν, 32 + |
| | | ν, . . . , 164 + ν |

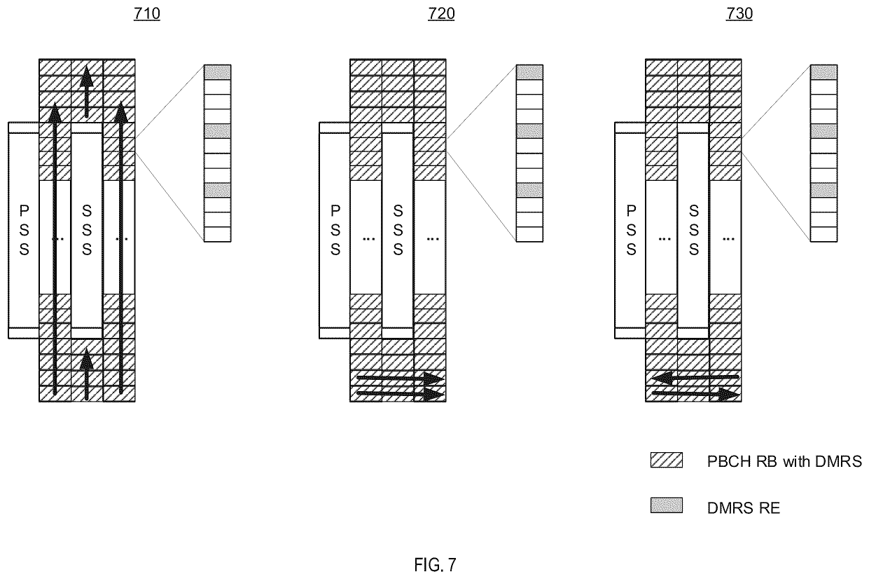

In various embodiments, the DMRS mapping rule may be modified by mapping DMRSs to the 20 RBs bandwidth in a manner of increasing in OFDM symbols in time domain first and then increasing in RBs in frequency domain, see two cases (720 and 730) as shown in FIG. 7. In case 720, the mapping rule includes always increasing in OFDM symbols in time domain. In case 730, the mapping rule includes increasing in OFDM symbols and then decreasing in OFDM symbols in an alternative and consecutive pattern. Various embodiments in the present disclosure may realize that the DMRS sequence may not be divided into several segments after puncturing. In comparison, for another case (710) of a current mapping rule, the DMRS mapping rule may be in a manner of increasing in RBs in frequency domain first and then increasing in OFDM symbols in time domain, and DMRS sequence may be divided into several segments after puncturing in the case (710) of the current rule.

Any of the embodiments in Embodiment Set II may be combined with any embodiment in Embodiment Set I to minimize PBCH performance degradation due to puncture.

### Embodiment Set III

The present disclosure describes various embodiments of a method, a system, or computer-readable medium for CORESET configuration in the frequency domain.

In some implementations, the frequency domain configuration of CORESET is indicated by the parameter frequencyDomainResources at the granularity of 6 RBs, so the CORESET resources in the frequency domain may be an integral multiple of 6 RBs. In narrowband scenarios that supported bandwidth can be, e.g., 3 MHz or 2.8 MHz, the quantity of available frequency domain resources is usually not an integer multiple of 6 RBs. In these scenarios, some bandwidths cannot be configured for CORESET.

In various embodiments, the configuration granularity of CORESET in the frequency domain is determined according to at least one of, channel bandwidth and high layer signaling (e.g., RRC signaling).

In various embodiment, the configuration granularity of CORESET in the frequency domain is determined according to channel bandwidth. In some implementations, the mapping relationship is predefined in the standard. For example, the configuration granularity of CORESET is 2 RBs for 14 RBs channel bandwidth; and/or the configuration granularity of CORESET is 3 RBs for 15 RBs channel bandwidth.

In various embodiments, the granularity in CORESET configuration may be indicated by high layer signal.

In various embodiments, the granularity in CORESET configuration for different bandwidth may be defined as Table 4. A three-bit higher layer signaling is used to indicate a granularity of CORESET configuration and the corresponding channel bandwidth.

TABLE 4
The granularity in CORESET configuration for different bandwidth

| | channel bandwidth | configuration granularity |
|---|---|---|
| index | (RBs) | (each bit represents RBs) |
| 0 | 12 | 6 |
| 1 | 14 | 2 |
| 2 | 14 | 7 |
| 3 | 15 | 3 |
| 4 | 15 | 5 |
| 5 | 16 | 2 |
| 6 | 16 | 4 |
| 7 | 16 | 8 |

In various embodiments, a optional configuration granularity set as {2, 3, 4, 5, 6, 7, 8} may be provided. The higher layer signal notifies a specific configuration granularity explicitly for each specific CORESET.

In various embodiments, a configuration granularity set for each type of bandwidth may be provided. As shown in Table 5, Table 6 and Table 7, a one-bit higher layer signaling is used to indicate a granularity of CORESET configuration.

TABLE 5
The granularity in CORESET configuration
for channel bandwidth of 14 RBs

| | configuration granularity |
|---|---|
| index | (each bit represents RBs) |
| 0 | 2 |
| 1 | 7 |

TABLE 6
The granularity in CORESET configuration
for channel bandwidth of 15 RBs

| | configuration granularity |
|---|---|
| index | (each bit represents RBs) |
| 0 | 3 |
| 1 | 5 |

TABLE 7
The granularity in CORESET configuration
for channel bandwidth of 16 RBs

| | configuration granularity |
|---|---|
| index | (each bit represents RBs) |
| 0 | 2 |
| 1 | 4 |

In various embodiments, by indicating the configuration granularity of CORESET flexibly, a wider frequency band range may be configured for CORESET, and the resource selection for CCE-to-REG mapping is more flexible. In various embodiments, the aggregation level supported by the narrowband system may be increased to support larger cell coverage.

The present disclosure describes methods, apparatus, and computer-readable medium for wireless communication. The present disclosure addressed the issues with transmitting information with limited channel bandwidth. The methods, devices, and computer-readable medium described in the present disclosure may facilitate the performance of wireless transmission between a user equipment and a base station, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
transmitting, by a base station, a synchronization signal or physical broadcast channel (SS/PBCH) block (SSB) to a user equipment (UE), wherein a channel bandwidth is smaller than a bandwidth of the SSB, by at least one of:
indicating, by the base station, an SSB index with at least one bit carried on a PBCH or a PBCH demodulation reference signal (DMRS) in the SSB;
mapping, by the base station, at least one of PBCH DMRS or PBCH data on the channel bandwidth or the bandwidth of the SSB; and
configuring, by the base station, a resource of a control resource set (CORESET) according to a frequency granularity.

2. The method according to claim 1, wherein the indicating the SSB index with at least one bit carried on the PBCH or the PBCH DMRS in the SSB comprises:
in response to a number of sequences for PBCH DMRS being one:
in response to a maximum number of SSBs being four, indicating the SSB index with two bits from a set of bits in a PBCH payload or an information element in a master information block (MIB); or
in response to the maximum number of SSBs being eight, indicating the SSB index with three bits from the set of bits in the PBCH payload or the information element in the MIB;
in response to a number of sequences for PBCH DMRS being two:
indicating a least significant bit (LSB) of the SSB index by initializing a scrambling sequence generator of PBCH DMRS sequence based on the LSB of the SSB index; and
in response to a maximum number of SSBs being four, indicating a most significant bit (MSB) of the SSB index with one bit from a set of bits in a PBCH payload or an information element in a MIB; or
in response to the maximum number of SSBs being eight, indicating two MSBs of the SSB index with two bits from the set of bits in the PBCH payload or the information element in the MIB; or
in response to a number of sequences for PBCH DMRS being four:
indicating two LSBs of the SSB index by initializing a scrambling sequence generator of PBCH DMRS sequence based on the two LSBs of the SSB index; and
in response to the maximum number of SSBs being eight, indicating a MSB of the SSB index with one bit from a set of bits in a PBCH payload or an information element in a MIB.

3. (canceled)

4. (canceled)

5. The method according to claim 2, wherein:
the set of bits in the PBCH payload comprises three bits in the PBCH payload, and the three bits in the PBCH payload comprises a sixth bit, a seventh bit, and an eighth bit in the PBCH payload; or
the information element in the MIB comprises at least one of an ssb-SubcarrierOffset or a subCarrierSpacingCommon.

6. (canceled)

7. The method according to claim 1, wherein:
the SSB comprises a first number of resource blocks (RBs) in the frequency domain, the channel bandwidth comprises a second number of RBs in the frequency domain, and the second number is smaller than the first number; and
the mapping at least one of PBCH DMRS or PBCH data on the channel bandwidth or the bandwidth of the SSB comprises:
mapping the PBCH data to consecutive resource elements to the first number of RBs, and
transmitting the PBCH data within the second number of RBs.

8. The method according to claim 1, wherein:
the SSB comprises a first number of resource blocks (RBs) in the frequency domain; the channel bandwidth comprises a second number of RBs in the frequency domain, and the second number is smaller than the first number; and
the mapping at least one of PBCH DMRS or PBCH data on the channel bandwidth or the bandwidth of the SSB comprises:
mapping the PBCH data to consecutive resource elements to the second number of RBs, and
transmitting the PBCH data within the second number of RBs.

9. (canceled)

10. The method according to claim 1, wherein:
the SSB comprises a first number of resource blocks (RBs) in the frequency domain, the channel bandwidth comprises a second number of RBs in the frequency domain, and the second number is smaller than the first number; and
the mapping at least one of PBCH DMRS or PBCH data on the channel bandwidth or the bandwidth of the SSB comprises:
mapping the PBCH DMRS or PBCH data to the first number of RBs in an order of firstly increasing in symbols in the time domain and then increasing in RBs in the frequency domain, and
transmitting the PBCH DMRS within the second number of RBs.

11. The method according to claim 1, wherein the configuring the resource of the CORESET according to the frequency granularity comprises:
determining the frequency granularity of the CORESET according to at least one of the following: the channel bandwidth or a high layer signaling.

12. (canceled)

13. The method according to claim 1, wherein the configuring the resource of the CORESET according to the frequency granularity comprises:
determining the frequency granularity of the CORESET according to a predefined rule based on the channel bandwidth; or
determining an index indicating the frequency granularity of the CORESET and the channel bandwidth according to a predefined table; and transmitting the index to the UE via a high layer signaling.

14. (canceled)

15. The method according to claim 1, wherein the configuring the resource of the CORESET according to the frequency granularity comprises:
determining the frequency granularity of the CORESET among a pre-configured frequency granularity set; and transmitting the frequency granularity of the CORESET to the UE via a high layer signaling; or
determining a pre-configured frequency granularity set according to the channel bandwidth; determining an index indicating the frequency granularity of the CORESET among the pre-configured granularity set; and transmitting the index to the UE via a high layer signaling.

16. (canceled)

17. (canceled)

18. (canceled)

19. The method according to claim 1, wherein:
the PBCH comprise a field indicating a CCE-REG-Mapping type of the CORESET.

20. The method according to claim 19, wherein:
the CCE-REG-Mapping type of the CORESET comprises an interleaved mapping or a non-interleaved mapping; or
at least one mapping parameter corresponding to the interleaved mapping comprises a pre-defined value.

21. An apparatus comprising:
a memory storing instructions; and
at least one processor in communication with the memory, wherein, when the at least one processor executes the instructions, the at least one processor is configured to cause the apparatus to perform:
transmitting a synchronization signal or physical broadcast channel (SS/PBCH) block (SSB) to a user equipment (UE), wherein a channel bandwidth is smaller than a bandwidth of the SSB, by at least one of:
indicating an SSB index with at least one bit carried on a PBCH or a PBCH demodulation reference signal (DMRS) in the SSB;
mapping at least one of PBCH DMRS or PBCH data on the channel bandwidth or the bandwidth of the SSB; and
configuring a resource of a control resource set (CORESET) according to a frequency granularity.

22. A method for wireless communication, comprising:
receiving, by a user equipment (UE), a synchronization signal or physical broadcast channel (SS/PBCH) block (SSB) from a base station, wherein a channel bandwidth is smaller than a bandwidth of the SSB, by at least one of:
determining an SSB index with at least one bit carried on a PBCH or a PBCH demodulation reference signal (DMRS) in the SSB;
receiving at least one of PBCH DMRS or PBCH data on the channel bandwidth or the bandwidth of the SSB; and
receiving a resource of a control resource set (CORESET) according to a frequency granularity.

23. The method according to claim 22, wherein the determining the SSB index with at least one bit carried on the PBCH or the PBCH DMRS in the SSB comprises:
in response to a number of sequences for PBCH DMRS being one:
in response to a maximum number of SSBs being four, determining the SSB index with two bits from a set of bits in a PBCH payload or an information element in a master information block (MIB); or
in response to the maximum number of SSBs being eight, determining the SSB index with three bits from the set of bits in the PBCH payload or the information element in the MIB;
in response to a number of sequences for PBCH DMRS being two:
determining a least significant bit (LSB) of the SSB index by detecting a sequence of PBCH DMRS; and
in response to a maximum number of SSBs being four, determining a most significant bit (MSB) of the SSB index with one bit from a set of bits in a PBCH payload or an information element in a MIB; or
in response to the maximum number of SSBs being eight, determining two MSBs of the SSB index with two bits from the set of bits in the PBCH payload or the information element in the MIB; or
in response to a number of sequences for PBCH DMRS being four:
determining two LSBs of the SSB index by detecting a sequence of PBCH DMRS; and
in response to the maximum number of SSBs being eight, determining a MSB of the SSB index with one bit from a set of bits in a PBCH payload or an information element in a MIB.

24. The method according to claim 23, wherein:
the set of bits in the PBCH payload comprises three bits in the PBCH payload, and the three bits in the PBCH payload comprises a sixth bit, a seventh bit, and an eighth bit in the PBCH payload; or
an information element in a MIB comprises at least one of an ssb-SubcarrierOffset or a subCarrierSpacingCommon.

25. The method according to claim 22, wherein:
the SSB comprises a first number of resource blocks (RBs) in the frequency domain, the channel bandwidth comprises a second number of RBs in the frequency domain, and the second number is smaller than the first number; and
receiving at least one of PBCH DMRS or PBCH data on the channel bandwidth or the bandwidth of the SSB comprises:
receiving the PBCH data in consecutive resource elements within the first number of RBs; or
receiving the PBCH data in consecutive resource elements within the second number of RBs; or
receiving at least one of PBCH DMRS or PBCH data within the second number of RBs.

26. The method according to claim 22, wherein the receiving the resource of the CORESET according to the frequency granularity comprises:
determining the frequency granularity of the CORESET according to a predefined rule based on the channel bandwidth.

27. The method according to claim 22, wherein:
the PBCH comprise a field indicating a CCE-REG-Mapping type of the CORESET.

28. The method according to claim 27, wherein:
the CCE-REG-Mapping type of the CORESET comprises an interleaved mapping or a non-interleaved mapping; or
at least one mapping parameter corresponding to the interleaved mapping comprises a pre-defined value.

29. An apparatus comprising:
a memory storing instructions; and
at least one processor in communication with the memory, wherein, when the at least one processor executes the instructions, the at least one processor is configured to cause the apparatus to perform:
receiving a synchronization signal or physical broadcast channel (SS/PBCH) block (SSB) from a base station, wherein a channel bandwidth is smaller than a bandwidth of the SSB, by at least one of:
determining an SSB index with at least one bit carried on a PBCH or a PBCH demodulation reference signal (DMRS) in the SSB;
receiving at least one of PBCH DMRS or PBCH data on the channel bandwidth or the bandwidth of the SSB; and
receiving a resource of a control resource set (CORESET) according to a frequency granularity.
